(19) United States
(12) Patent Application Publication
(10) Pub. No.: US 2023/0391643 A1
(43) Pub. Date: Dec. 7, 2023

(54) METHOD OF TREATMENT OF WATER PRODUCED BY CHEMICAL FLOCCULATION USING ANIONIC SURFACTANT AND CATIONIC POLYELECTROLYTE AND USE OF THE SAME

(71) Applicants: PETRÓLEO BRASILEIRO S.A. - PETROBRAS, Rio de Janeiro (BR); UNIVERSIDADE FEDERAL DO RIO GRANDE DO SUL - UFRGS, Porto Alegre (BR)

(72) Inventors: BYRON ROSEMBERG DOS SANTOS COSTA, Rio de Janeiro (BR); LUCIANA KAORI TANABE, Porto Alegre (BR); SILVIO EDEGAR WESCHENFELDER, Rio de Janeiro (BR); HENRIQUE ALBERTON DE OLIVEIRA, Porto Alegre (BR); ANDRÉ CAMARGO DE AZEVEDO, Porto Alegre (BR); ALLAN RAMONE DE ARAUJO SCHARNBERG, Porto Alegre (BR)

(21) Appl. No.: 18/326,777

(22) Filed: May 31, 2023

(30) Foreign Application Priority Data
Jun. 1, 2022 (BR) 10 2022 010729 7

(51) Int. Cl. C02F 1/56; C02F 1/54; C02F 1/24

(52) U.S. Cl. CPC C02F 1/56; C02F 1/547; C02F 1/24; C02F 2101/32

(57) ABSTRACT

A method of treating produced water on offshore platforms and onshore facilities is described. The method can be applied to or integrated into other already-installed processes and/or technologies for the treatment of produced water, being characterized by the combined addition of anionic surfactant and cationic polyelectrolyte for the destabilization and flocculation of oily emulsions characteristic of produced water, preliminarily to the separation steps (hydrocyclones and/or flotators). The different points and alternatives of reagent injection combinations are adaptable to equipment and units already in operation.

### FIELD OF THE INVENTION

The present invention pertains to the field of sustainable development, in technologies for water treatment and reuse. More specifically, the application of the invention is related to the treatment of produced water on offshore platforms and onshore facilities.

### DESCRIPTION OF THE STATE OF THE ART

It is known that, during oil extraction on offshore platforms, part of the oil enters into emulsion with water, generating an effluent known as “produced water”. The emulsification process begins with the passage of the oil and water mixture through the base of the well, flowing under high pressure along the production string. Along the way, pressure and high shear imposed by pumps, valves and other hydraulic constrictions reduce the size of oil droplets dispersed in the aqueous fraction. In addition, crude oil naturally has emulsifying agents responsible for stabilizing the emulsion, such as suspended solids, asphaltenes, organic acids and other chemical components, which are also present in produced water. Further, the presence of dissolved organic compounds in the produced water is associated with problems of corrosion of platform structures and, among other things, with increased ecotoxicity of the effluent, increasing its environmental impact at the time of disposal or, even, making it impossible to use the same in the reinjection. Thus, produced water (PW) is a natural by-product of oil and gas production, whose composition varies according to the location and throughout the life of the extraction well. These waters include two main matrices: formation water and injected water. The so-called formation waters have been confined for millions of years next to geological reservoirs of oil and gas, between layers of impermeable rocks, being extracted along with the oil in the drilled well. For maritime disposal, these waters must comply with the current environmental legislation that, in the case of maritime platforms in Brazil (offshore), are governed by Resolution CONAMA 393/2007, which determines the limits of concentration of total oil and grease content (OGC) allowed for continuous discharge of effluents of 42 mg/L (daily limit) and monthly simple arithmetic mean of 29 mg/L.

In the current scenario of oil and gas extraction, the management of produced water is a challenge, since the volume generated during oil extraction is increasing and the maintenance of the economically sustainable production curve of oil in “mature” fields is hampered by technical issues. The reagents currently used are inorganic salts such as iron or aluminum sulfate, iron chloride, or polymerized coagulants such as aluminum and/or iron polychlorides and organic polyelectrolytes, including polyethyleneimine (PEI) and polyacrylamides (PAA), generally used as flocculants. However, these reagents require hydrodynamic conditions of slow mixing for destabilization of the oil-in-water emulsion and growth of flocs in residence times of the order of ten minutes, in reactors/hydraulic flocculation pipelines or in flotation tanks, in addition to producing large amount of sludge, which returns to the process.

The conventional treatment of water produced on offshore platforms aims at removing the oily phase (dispersed droplets) from the aqueous matrix, comprising gravitational separation steps, hydrocyclones and flotators. These produced water treatment equipment have a reduced efficiency in the removal of solids and oil droplets smaller than 5.0 μm, mainly in cases where the aggregation step (flocculation) is non-existent or insufficient. Such conditions limit the overall efficiency of the treatment and prevent the maintenance of the processing capacity of produced water for disposal, not meeting the growing demand for the largest extracted volumes of water, mainly in “mature” wells. Consequently, oil production is limited to the processing capacity of this effluent. Furthermore, the low efficiency of conventionally employed destabilization and flocculation routes for treatment of produced water results, in most cases, in treated waters with contents of suspended solids, oils and greases (OGC) in disagreement with the requirements demanded for reinjection in the reservoirs, making the use of this procedure unfeasible without subsequent steps of treatment and adaptation of the reinjection water. In the case of treatment of produced water on offshore platforms, conventional chemical flocculation techniques are currently an impediment to expanding treatment capacity, since it is not possible to increase the application rate, or treatment flow rate per equipment area. (m³/m²·hour) of the installed flotators. In this way, the expansion of treatment units requires a larger area for the disposal of equipment.

The interfacial properties of mixtures and the conditions for the formation of surfactant-polymer complexes (PSC) have been studied by several researchers (Khan, Mohammad Yunus, Abhijit Samanta, Keka Ojha, and Ajay Mandal. 2008. “Interaction between Aqueous Solutions of Polymer and Surfactant and Its Effect on Physicochemical Properties.” Asia-Pacific Journal of Chemical Engineering 3(5):579-85. doi: 10.1002/apj.212.; Khan, Nasreen, and Blair Brettmann. 2018. “Intermolecular Interactions in Polyelectrolyte and Surfactant Complexes in Solution.” Polymers 11(1). doi: 10.3390/polym11010051.; Nambam, J. S., and John Philip. 2011. “Competitive Adsorption of Polymer and Surfactant at a Liquid Droplet Interface and Its Effect on Flocculation of Emulsion.” Journal of Colloid and Interface Science 366(1):88-95. doi: 10.1016/j.jcis.2011.07.100.). Some researchers have already evaluated the removal of other organic and inorganic contaminants by the PSC formation technique, namely the removal of suspended solids—kaolin (Besra, L., D. K. Sengupta, S. K. Roy, and P. Ay. 2004. “Influence of Polymer Adsorption and Conformation on Flocculation and Dewatering of Kaolin Suspension.” Separation and Purification Technology 37(3):231-46. doi: 10.1016/j.seppur.2003.10.001.) and alumina (Matusiak, Jakub, and Elzbieta Grzgdka. 2020. “Cationic Starch as the Effective Flocculant of Silica in the Presence of Different Surfactants.” Separation and Purification Technology 234 (May 2019). doi: 10.1016/j.seppur.2019.116132.); and metal ions (Shen, Li Cheng, Xuan Tung Nguyen, and Nicholas P. Hankins. 2015. “Removal of Heavy Metal Ions from Dilute Aqueous Solutions by Polymer-Surfactant Aggregates: A Novel Effluent Treatment Process.” Separation and Purification Technology 152:101-7. doi: 10.1016/j.seppur.2015.07.065) of aqueous solutions. However, applications in the flocculation of produced water or oily emulsions have not yet been explored by the scientific community or by the productive sector. These complexes are formed under specific physicochemical conditions, generally in saline mixtures, due to the salting-out effect, which considerably reduces the solubility of the reagents and the performance of electrostatic forces in the aqueous medium. Parameters of the reagents (molecular weight, nature and charge density, hydrophobicity) and of the mixture (molar ratio, pH) interfere in the formation of PSC, which behave as a dispersed phase.

As for possible conflicts with the claim of this invention, the document ROCHA, Breno da Silva stands out. “Avaliação de metodologia combinada com uso de tensoativos e polieletrdlitos para tratamento de dgua produzida” (“Evaluation of a methodology combined with the use of surfactants and polyelectrolytes for the treatment of produced water”), Thesis (Master in Chemical Engineering)—Technology Center, Federal University of Rio Grande do Norte, Natal, 2018, which aims at evaluating the hypothesis of synergy between two coagulants compared to the individual contribution of each of them. However, there is no intention of the author to propose a modification of the coagulation/flocculation process such as the object of the present invention.

The author uses a mixture of carboxylated anionic surfactants (saponified soap base, comprising a mixture of coconut oil and bovine tallow) and a polyelectrolyte as an additional “coagulant” to the commercial tannin TANFLOC SS (a cationic coagulant) in the aggregation and separation of synthetic oily emulsion, as quoted on page 15, fourth paragraph: “This work aims at evaluating the effect of the simultaneous use of surfactants and polyelectrolytes for the treatment of produced water to adapt to the parameters that meet national legislation”, that is, the two products are added at the same time to promote the coagulation/flocculation process, with the surfactant acting as a coagulant, such as the commercial tannin TANFLOC SS. The initial stages of the coagulation/flocculation process are not modified and remain unchanged throughout all the tests performed by the author.

This intention is also confirmed in the documents used as a reference by the author, in which the use of surfactants is motivated, either by the charge neutralization action of the oil droplets, or by the reduction of the water-oil interfacial tension, favoring the process of coalescence of oil droplets in synthetic or real effluents. And, additionally, by the author's own writing, as quoted on page 81, third paragraph: “The chemical products were initially put in contact in the beaker (that is, simultaneously) and then the produced water was added”.

Although the author uses a mixture of carboxylate surfactants, given the characteristic of the produced water, these ions are converted either to an insoluble salt with calcium ions [(RCOO)₂Ca]₍ₛ₎ or to a soluble complex [RCOOCa]⁺, so that the active compound is a cationic coagulant, such as the commercial tannin TANFLOC SS. The author also formulates the hypothesis on page 79, second paragraph, as quoted: “Right at the beginning of the slow stirring, a large formation of long and irregular flocs was already observed throughout the solution. The flocs are light in color and can be seen in FIG. 28. According to Melo (2015), anionic surfactants, in the presence of multivalent metals, such as calcium ion (Ca²⁺), present in synthetic produced water, promote the formation of an insoluble floc (carboxylate of calcium), which will maintain interaction between the surfactant and the oily drops.”

That said, it can be concluded that the author's proposal is not to be confused with the present invention, since it does not propose to reformulate the conventional coagulation/flocculation process, above all, in the suppression of the slow step of this process.

In addition, the author reports that there are gains of 11% in oil removal efficiency with the combination of products, when compared to the efficiency of the isolated use of the surfactant mixture, as quoted on page 85, second paragraph: “For the case of adding 200 mg/L of base soap, the increase in efficiency was 11%, taking the treatment efficiency from 85% to 94%.” And yet, at the conclusion of the study, the wording conveys the meaning that this efficiency gain is in relation to the individual contribution of the products, as quoted on page 88, last paragraph: “As the main objective of this work, the efficiency of the tests using the two products in combination presented a synergy and achieved significant increases in efficiency, justifying the application on a pilot and perhaps industrial scale. Efficiency gains with combined use reached an 11% increase in efficiency, with a treatment using 200 mg/L of base soap and 20 mg/L of polyelectrolyte. The replacement of the electrolyte product by surfactant, when applied, can bring significant financial and logistical gains to an industrial oily effluent treatment plant”, that is, the author does not prove synergy between the products, but concludes as if he had proved this hypothesis.

The study, therefore, in addition to not proving synergy between coagulants, does not have the same scope as the present invention. It is important to mention that the present invention is not structured on the synergy between surfactant and polyelectrolytes to achieve a removal efficiency superior to the individual contribution of each one of them, but on the reformulation of the coagulation/flocculation process, eliminating the slow step of this process and inducing a segregation practically instantaneous between the oil/water phases. The process described in the present invention has discrete steps, in which each of the products is used in a single sequence, in such a way that changing this sequence (surfactant-polyelectrolyte) annuls the process, leading to the stabilization of the oily emulsion. The individual use of the products is also not effective in the treatment of produced water.

In addition, said document is deficient in terms of explaining the mechanisms involved and understanding the main parameters that determine the efficiency of produced water treatment. The formation of surfactant-polymer complex precipitates is not theorized or even mentioned as the agents or phenomena responsible for the capture and aggregation of dispersed oil droplets. It is also noted that the surfactant used in the study is a base soap produced by hand, without a defined characterization of the surfactants present in the product. On the other hand, in the present invention, the use of anionic surfactants is disclosed, which include (not being limited to only these) those containing carboxylate, sulfonate, sulfate ions and known mixture thereof, in the form of solid reagents or aqueous solutions developed, produced and marketed by companies established in the market. The use of artisanal saponified products without known composition is not addressed to in the present invention. Examples of recommended anionic surfactants include long-chain sulfonates and alkylaryl sulfonates, such as sodium dodecylbenzene sulfonate and sodium dodecyl sulfate. More than one surfactant can be used, being added jointly or separately during the produced water treatment process.

As for the polyelectrolyte used in the study in question, it is a cationic polymer of natural origin (tannin, chemically modified to confer a positive charge to the molecule), with the experiments of the study limited to the use of the same. On the other hand, the present invention specifically discloses the use of a polyelectrolyte comprising water-soluble polymeric organic flocculants with ionizable groups, which generate a positive charge. Examples of recommended organic flocculants include, but are not limited to, polyacrylamide, polyalkyleneimines and polyethyleneamine based polymers. Specifically, the use of a cationic polyacrylamide with charge density between 15 and 75% and molecular weight preferably between 6 and 9 MDa (mega Daltons) is suggested. Particularly, natural tannins, anionic sulfonated tannins, lignins and sulfonated lignins, can be used as surfactant agents in the proposed method, together with another cationic polyelectrolyte.

In the document in question, high dosages (between 100 and 200 ppm) of soap in the process, together with the polyelectrolytes of tannins, were further reported. In the proposed invention, the inventors report the use of a synthetic anionic surfactant commercially known as Sodium Dodecyl-Benzene Sulfonate (SDBS) in much smaller dosages (20 ppm), together with high molecular weight cationic polyacrylamide (6 to 9 MDa) and moderate to high cationic charge density (15 to 75%).

Finally, it should further be noted that the present invention comprising a treatment method for produced water to be implemented in existing or future plants, based on the association of advanced flocculation processes (using the combination of proposed reagents), with or without Dissolved Air Flotation (DAF). However, in the document under analysis, the separation method used was sedimentation, which are unsuitable for offshore processing.

Among the technical advantages claimed in the method of the present invention, the high flocculation speed is pointed out, which requires a reduced residence time in the feed pipes of the flotators and in the flotation reactors themselves, causing an increase in the treatment capacity of the units already installed on the platform (reduction of the residence time for the process to be carried out). The flocculation time evaluated and validated in the document in question (15 minutes of total flocculation time) is much higher than the residence time of the present invention, in the order of seconds (from 5 to 60 seconds), without the need for the slow mixing stage, as it is a process/method that involves chemical complexation between the involved reagents. The process studied in said document, therefore, if applied at an industrial level, does not offer any technical advantage over the method currently used, and would probably not fit the performance requirements of flotators for treatment of produced water, mainly on offshore platforms.

In this way, it is evident that the treatment of oily emulsion presented in the document in question does not relate to the present invention.

A second conflict to the claim is document US20170144906A1. This document refers to an American patent application that describes a process for the use of inorganic coagulants (aluminum chloride or polyaluminum chloride, as mentioned) in the treatment of effluents, which polymerize in solution forming cationic polymers that induce charge neutralization of droplets and suspended solids, leading to the formation of flocs that can float or settle. Therefore, it is a conventional coagulation/flocculation process directed to the context of the oil and gas industry, without any similarity with the scope of the present invention, since it uses reagents of a different nature than the combination of anionic surfactant and cationic polyelectrolyte as claimed. Further, the proposed invention proposes several alternatives for reagent injection points specifically in produced water treatment plants on offshore platforms.

A third document, CA2138472C, addresses to a Canadian patent that refers to a method of optimizing the dosage of polyelectrolytes used in the coagulation/flocculation process through the use of tracers reactive to polyelectrolytes and measurement by fluorescence spectroscopy. It is not, therefore, a process for treating produced water like the present invention. Furthermore, nowhere in the text does the patent refer to the use of surfactants associated with polyelectrolytes.

In general, the main advantages of the present invention include: i. increase in the treatment capacity of existing facilities without expanding the area occupied by equipment; ii. the generation of a stream of treated water suitable for marine disposal and reinjection as a method of oil recovery; and iii. the development of produced water treatment units, with the chemical technique of flocculation.

Thus, it is clear that the above-commented documents do not present similar studies or processes, nor the possible technical advantages of the present invention. Therefore, it is possible to note that the state of the art lacks an unconventional chemical flocculation system for treatment without the need of using a larger area or new equipment. The proposed method, to be detailed below, aims at achieving this objective without compromising the quality of treated water for marine disposal and reinjection as an oil recovery method.

### BRIEF DESCRIPTION OF THE INVENTION

Initially, it should be noted that the following description is based on the preferred embodiments of the invention, without being limited by them.

The present invention describes an unconventional chemical method of flocculation for treatment of production water, which comprises the use of a combination of an anionic surfactant and a cationic polyelectrolyte, added together to the effluent, to generate surfactant-polymer complexes and destabilization/aggregation of dispersed oil droplets; or the use of an anionic surfactant for conditioning the dispersed oil droplets, and subsequent addition of a cationic polyelectrolyte, for formation of surfactant-polymer complexes and flocculation of the conditioned oil droplets.

The present invention provides for changes in the set of destabilization and aggregation reagents (flocculation) of produced water, to be injected into existing treatment facilities, in order to increase the kinetics of the flocculation step of the dispersed droplets. The proposed method includes of the formation of surfactant-polymer complexes (PSC) in saline mixtures of surfactants and oppositely charged flocculant polymers. The flocculation of water produced by the formation of PSC occurs very quickly, efficiently removing the dispersed fraction by micellar entrapment/adsorption mechanisms followed by flocculation, before separation by flotation. In this way, the present invention will enable greater reliability and robustness in the treatment of produced water in different scenarios, with a reduction of dispersed OGC and ecotoxicity of the treated effluent. This method will allow the reduction of the residence time of the effluent in the flocculation/dispersed oil separation reactors, increasing the treatment flow rate, dispensing with spatial/physical expansion of the equipment, maintaining or improving the quality of the treated water. The use of this method will allow the development of new products, considering the innovative capabilities of the invention.

The invention proposes the use of surfactants to increase the charge density of oil droplets, using anionic surfactants or natural tannins and anionic tannins. The increase in charge density, in turn, promotes the acceleration of floc growth in the presence of oppositely charged polyelectrolytes (cationic polyelectrolyte) added in the process sequence.

The invention, therefore, proposes to eliminate the slow step of the coagulation/flocculation process, in order to reduce the residence time of the effluent and, indirectly, expand the treatment capacity of the equipment and/or treatment plants of produced water.

### BRIEF DESCRIPTION OF THE FIGURES

To assist in identifying the main characteristics of the present invention, the figures to which references are made are presented, as follows:

FIG. 1 illustrates a simplified schematic flowchart, typical of a conventional offshore produced water treatment system.

FIG. 2 presents the detailed flowchart of a conventional offshore produced water treatment system. Points A, B, C and D indicate the possible reagent injection points, as claimed in the present invention.

FIG. 3 presents the results of bench studies of treatment of produced water simulated by flocculation-flotation by dissolved air under the following conditions: OGC and residual turbidity as a function of SDBS concentration; 20 mg/L cationic polyacrylamide (15% charge density, Molar Mass between 6 and 9 MDa, emulsified product with 35% active matter) and pH=6.5.

FIG. 4 shows the results found for bench studies of treatment of produced water simulated by flocculation-flotation by dissolved air, under the following conditions: OGC and residual turbidity as a function of the concentration of cationic polyacrylamide (PAA); SDBS at 20 mg/L and pH=6.5.

FIG. 5 shows digital images of oily flocs formed in saline with 20 mg/L of PAA (CE 814) and 20 mg/L of SDBS.

### DETAILED DESCRIPTION OF THE INVENTION

Preliminarily, it should be highlighted that the description that follows will start from a preferred embodiment of the invention. As will be apparent to technician skilled on the subject, however, the invention is not limited to that particular embodiment.

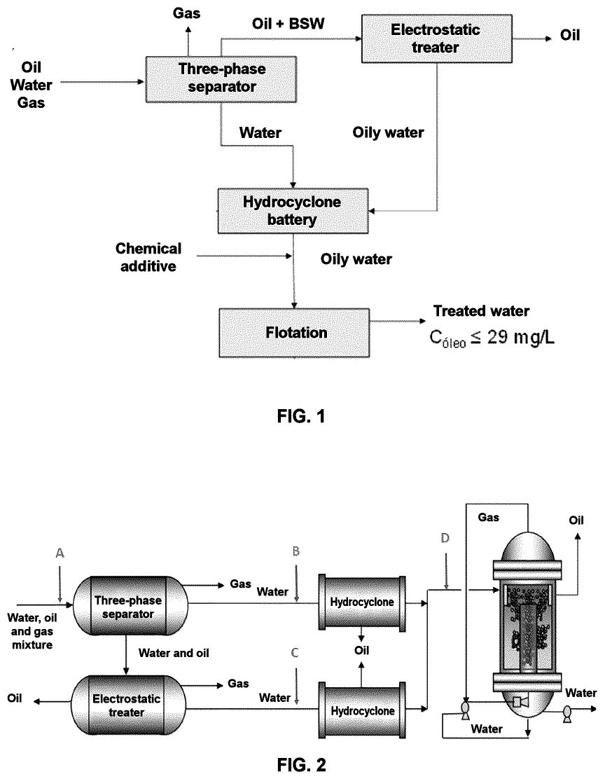

Thus, it should be noted that the present invention is not limited by the characterization of the application of reagents (surfactants and polyelectrolytes) in produced water treatment systems characterized by the flowcharts in FIG. 1 or FIG. 2, and may be characterized by the sequential/consecutive/combined use of the reagents (anionic surfactant and cationic polyelectrolyte) in any produced water treatment system with specific layout, and with injection of reagents at any point upstream or downstream of hydrocyclones and/or flotators.

Suitable anionic surfactants include (but are not limited to these only) those containing carboxylate, sulfonate and sulfate ions and other groups whose interaction with the aqueous medium will produce anionic charge. Examples of recommended anionic surfactants include medium to long chain sulfonates and alkylaryl sulfonates, such as sodium dodecylbenzene sulfonate and sodium dodecyl sulfate. More than one surfactant can be used, being added jointly or separately during the produced water treatment process. Further, surfactants with a carbonic base (chain) of natural origin, such as tannins and lignins, chemically modified by the introduction of sulfonated radicals or not, are also encompassed by the method described by this invention.

Suitable cationic polyelectrolytes include (but are not limited to) water-soluble polymeric organic flocculants with positively charged ionizable species. Examples of recommended organic flocculants include, but are not limited to, polyacrylamide, polyalkyleneimines and polyethyleneamine. It is suggested the use of a cationic polyacrylamide with charge density between 15 and 75% and molecular weight, preferably, between 6 and 9 MDa (mega Daltons).

FIG. 1 illustrates a simplified schematic flowchart of a conventional produced water treatment system for marine disposal or reinjection into oil extraction wells. Such a figure shows the produced water outlets from the three-phase separator and the electrostatic treater, containing dispersed oil and dissolved organic compounds. In general, this oily water is directed to the hydrocyclone battery, where the gravimetric separation of the larger dispersed oily fraction takes place, at a cut-off diameter of droplets between 50 and 150 μm. Then, the chemical flocculation reagents are added upstream of the flotators, which aim at obtaining a stream of treated water with a residual OGC concentration of less than 29 mg/L.

FIG. 2 shows a simplified flowchart of a conventional offshore produced water treatment system, and the possible addition points of the reagents claimed in this invention. Points A, B and C are possible injection points for the upstream or downstream piping of the three-phase separator and the electrostatic treater and hydrocyclones. Point D is where normally the flocculation reagents are added, upstream of the flotators, for final treatment of produced water for disposal. The different possibilities for altering the conventional treatment process proposed in this invention are described in the next paragraphs.

At point A, the addition of reagents is made upstream of the three-phase separator, it being possible to add only the anionic surfactant (between 5 and 300 ppm), or the combination of the surfactant with the cationic polyelectrolyte (between 5 and 300 ppm), being added sequentially. If only the surfactant is added, the entire three-phase mixture (oil, water and gas) will be mixed with the anionic reagent, and due to the amphiphilic nature of the molecules, the dispersed oil fraction will preferentially react with the hydrophobic region of the amphiphilic molecules, resulting in the phenomenon of “conditioning” of oil droplets. The purpose of this alternative is to increase the contact time between the reagents and to provide conditions for complete mixing, for the formation of micellar complexes on the surface of oil droplets conditioned with surfactant, right after the addition of the cationic polyelectrolyte, in a later step at addition points B, C, and/or D.

In the case of the sequential addition of the reagents at point A, the instantaneous formation of micellar precipitates from the interaction of the surfactant with the polyelectrolyte will occur at the inlet of the three-phase separator. The objective of this alternative is to promote the capture and flocculation of oil droplets in the first step of separation between the oily and aqueous phases, maximizing the oil production capacity and reducing the dispersed and dissolved oil content of the water produced for the following treatment steps.

Points B and C indicate the locations with the possibility of adding the reagents upstream of the gravimetric separation step in the hydrocyclone batteries. Point B refers to the outlet of the three-phase separator, and point C to the outlet of the electrostatic separator. The possible combinations of reagents to be added, each in a concentration between 5 and 300 ppm, can be considered for both points, or for each of the points individually.

One of the alternatives for adding reagents at points B and C comprises adding the anionic surfactant (between 5 and 300 ppm), individually, for conditioning the oil droplets present in the oil and water mixture and subsequent addition of the cationic polyelectrolyte at point D (between 5 and 300 ppm), upstream of the flotator. This alternative aims at promoting the conditioning of the oil droplets dispersed with the anionic surfactant molecules, using the contact time and mixing intensity promoted in the hydrocyclone.

Another possibility at points B and C comprises injecting the cationic polyelectrolyte alone (between 5 and 300 ppm), when the oily waters were previously conditioned with anionic surfactant, injected alone at point A (between 5 and 300 ppm). In this way, the micellar precipitates will form instantly after the injection of the cationic polyelectrolyte on the surface of the oil droplets conditioned by the surfactant molecules.

An alternative is the injection of both reagents (anionic surfactant and cationic polyelectrolyte) together, at points B and/or C, aiming at the formation of micellar precipitates and the flocculation of dispersed droplets prior to the separation in the hydrocyclone, maintaining the same recommended concentrations. This alternative aims at increasing the number of oil droplets to be separated in the hydrocyclone, possibly resulting in greater oil recovery and the generation of a stream of treated water with less dispersed oil content, for subsequent treatment by flotation.

The alternatives presented in the paragraphs above, depending on the characteristics of the produced water effluent from the three-phase and electrostatic separators, may result in a removal of OGC by gravimetric separation in the hydrocyclone battery, reaching the quality of treated water with adequate specification for marine disposal, wherein the flotation step is unnecessary, when the objective is the disposal of treated produced water.

Finally, the injection of reagents at point D, where flocculant reagents are normally added, upstream of the flotators, includes the possibility of injecting the cationic polyelectrolyte alone (between 5 and 300 ppm), for the formation of micellar precipitates in oily water previously conditioned with anionic surfactant (between 5 and 300 ppm), added at points A and/or B and/or C, or in the addition of both reagents (anionic surfactant and cationic polyelectrolyte) together, for the instantaneous formation of micellar precipitates and flocculation of oil droplets.

Thus, based on the above description, the present invention provides possibilities for the application of non-conventional reagents for the treatment of produced water, highlighting their forms and the points of addition in the process, allowing different methodologies to be used in order to adapt the treated water for the intended purposes. In addition to increasing the treatment capacity of existing facilities, other advantages can be achieved through the present invention, by developing new equipment and/or systems for treating produced water optimized for specific scenarios.

In this context, the innovations and advantages proposed by the present invention comprise:
a. Combination of reagents (anionic surfactant plus cationic polyelectrolyte) with the aim of destabilizing the oily emulsion and aggregating dispersed oil droplets, through the mechanism of formation of precipitated complexes (insoluble) that strongly interact with the dispersed oil;
b. Description of possible reagent injection points, in water treatment plants produced on offshore platforms or in fixed facilities onshore; and/or
c. Reduction of the residence time necessary for the formation of flocs and consequent increase in the treatment capacity of existing facilities.

In addition, the main advantages expected from the execution of the present invention are related to the following aspects:

—Economic/Productivity:

The increase in the treatment capacity of existing facilities will allow for an increase in oil production, solving the problem of production “bottleneck” in unforeseen scenarios of water production flow rate. Savings in the treatment process obtained by reducing the use of conventional reagents, especially if the acidification of the produced water is required. Further, the treated water can, when applicable, be reinjected, generating a reduction in the costs of obtaining reinjection water and greater oil extraction efficiency.

—Health/Safety:

Maintaining and adapting the quality of treated water to the levels required by environmental legislation will guarantee the conditions for the discharge of offshore produced water, conserving the integrity of marine and coastal ecosystems.

—Reliability:

The robustness and resilience of the treatment process are proven by the operation ability to adapt to different scenarios of characteristics of the produced water to be treated (operational and physical-chemical parameters, such as total oil and grease content, dissolved solids, salinity, temperature and other process interferents) by adjusting the concentration of reagents, especially the anionic surfactant, aiming at maintaining the formation of flocculant species (PSC).

—Environmental:

Removing oil dispersed in treated water reduces/minimizes environmental impacts at the disposal site and related to the operation. The invention should contribute to comply with current legislation on offshore disposal of produced water, to reduce oily problems at disposal points close to platforms and to reduce the ecotoxicity of treated effluents. Improved quality of treated water also makes it possible to use it for reinjection, reducing water consumption and disposal. Maintaining and adapting the quality of treated water to the levels required by environmental legislation will ensure the conditions required for the discharge of offshore produced water, conserving the integrity of marine and coastal ecosystems.

—Other Advantages:

Possibility of designing and installing future produced water treatment compact units using the flocculation technique and the different proposed reagent injection points.

### EXAMPLE OF EMBODIMENT

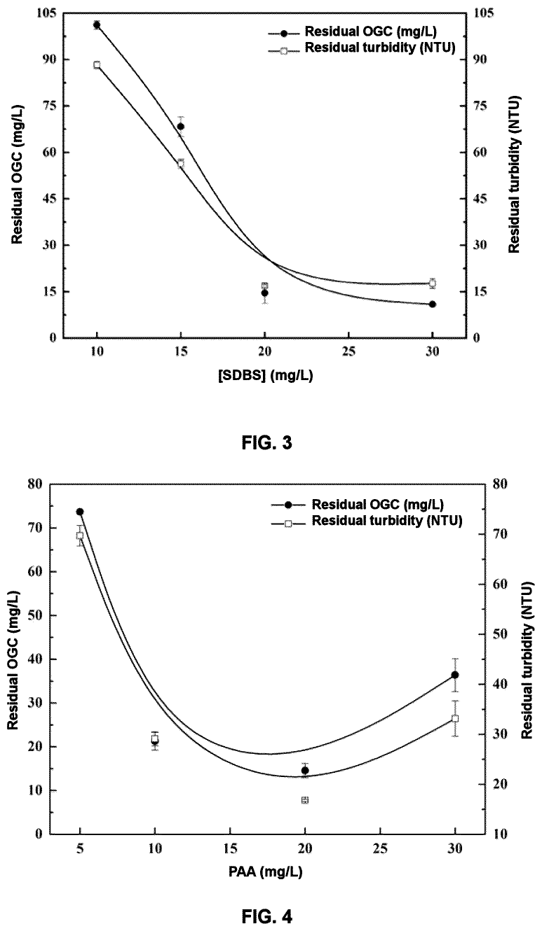

The method to be protected was tested in bench studies of produced water treatment simulated by flocculation-flotation by dissolved air under the following conditions (according to FIGS. 3 and 4):
1) Residual OGC and Turbidity as a function of SDBS concentration; 20 mg/L cationic polyacrylamide (15% charge density, Molar Mass between 6 and 9 MDa, emulsified product with 35% active matter) and pH=6.5; and
2) Residual OGC and Turbidity as a function of cationic polyacrylamide (PAA) concentration; SDBS at 20 mg/L and pH=6.5.

In this way, the destabilization (flocculation) of synthetic produced water (oily emulsions prepared in saline solutions, with an average droplet diameter of 5 μm) was evaluated by the combination of anionic surfactants (sodium dodecylbenzene sulfonate SDBS, or sodium dodecyl sulfate—SDS) and a cationic polyelectrolyte (cationic polyacrylamide with 15% charge density and molecular weight between 6 and 9 mega Daltons). The flocculation of the dispersed droplets was promoted with 2 minutes of conditioning the emulsion with the anionic surfactant, followed by the injection of flocculant polymer at the base of the column. The mixing time for the formation of flocs, after the polymer injection, was 15 seconds.

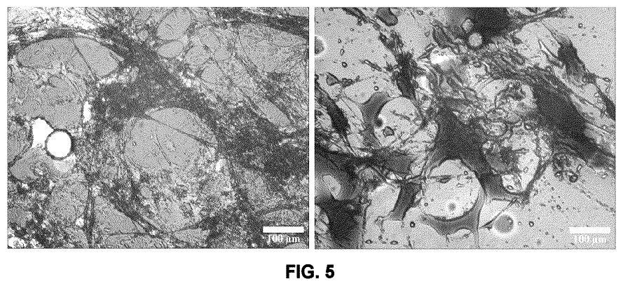

Next, the formed flocs were removed by dissolved air flotation, using a benchtop saturator vessel coupled to a needle valve for bubble generation, with 20% recycle rate and 5 minutes of separation. The results obtained with both surfactants showed that the treated water presented a residual OGC compatible with the environmental disposal parameters in a wide range of reagent concentrations, and the best results indicated a treated water with residual OGC lower than 15 mg/L. FIG. 5 shows images of the flocs formed by the polymer-surfactant interaction.

Numerous variations affecting the scope of protection of the present application are allowed. This reinforces the fact that the present invention is not limited to the above-described particular configurations/embodiments.

The technicians skilled on the subject will value the knowledge presented herein and will be able to reproduce the invention in the forms presented and in other variants, encompassed by the scope of the appended claims.

1. A chemical method of destabilization and flocculation of water produced on offshore oil extraction platforms, the method comprising:
sequentially adding 5 to 300 ppm of an anionic surfactant and 5 to 300 ppm of a cationic polyelectrolyte to an effluent as flocculation reagents for the generation of surfactant-polymer complexes and destabilization/aggregation of the dispersed oil droplets; and
removing one or more formed flocs by dissolved air flotation (DAF).

2. (canceled)

3. (canceled)

4. (canceled)

5. (canceled)

6. The method of claim 19, wherein the injection of the combination of the anionic surfactant with the cationic polyelectrolyte is, upstream of the three-phase separator.

7. (canceled)

8. (canceled)

9. (canceled)

10. The method of claim 19, wherein the injection of the combination of anionic surfactant with the cationic polyelectrolyte is downstream of the three-phase separator and upstream of the one or more hydrocyclone batteries.

11. The method of claim 19, wherein the injection of the combination of anionic surfactant with the cationic polyelectrolyte is downstream of the electrostatic treater and upstream of the one or more hydrocyclone batteries.

12. The method of claim 19, wherein the injection of the combination of anionic surfactant with the cationic polyelectrolyte is downstream of the one or more hydrocyclone batteries and upstream of the flotation.

13. (canceled)

14. The method of claim 1, wherein the anionic surfactants comprises one or more of: carboxylate, sulfonate, sulfate ions, sodium dodecylbenzene sulfonate (SDBS), sodium dodecyl sulfate (SDS), anionic tannins, and anionic lignins.

15. The method of claim 1, wherein the cationic polyelectrolytes comprise water-soluble polymeric organic flocculants with ionizable species of positive charge.

16. The method of claim 15, wherein the cationic polyacrylamide has a charge density between 15% and 75% and a molecular weight between 6 and 9 MDa.

17. The method of claim 1, further comprising mixing the anionic surfactant, the cationic polyelectrolyte, and the effluent for 5-60 seconds prior to removing the one or more flocs.

18. (canceled)

19. The method of claim 1, wherein the offshore oil extraction platform comprises a system comprising a three-phase separator, an electrostatic treater, one or more hydrocyclone batteries, and a flotation.

20. The method of claim 15, wherein the water-soluble polymeric organic flocculants with ionizable species of positive charge comprise polyacrylamide, polyalkyleneimines, or polyethyleneamine.

21. A method of destabilization and flocculation of water produced on offshore oil extraction platforms, the method comprising:
adding 5 to 300 ppm of an anionic surfactant for conditioning a dispersed oil droplets;
subsequently adding 5 to 300 ppm of a cationic polyelectrolyte to an effluent for forming surfactant-polymer complexes and the flocculation of the conditioned oil droplets; and
removing one or more formed flocs by dissolved air flotation.

22. The method of claim 21, wherein the offshore oil extraction platform comprises a system comprising a three-phase separator, an electrostatic treater, one or more hydrocyclone batteries, and a flotation.

23. The method of claim 22, wherein adding anionic surfactant comprises injecting the anionic surfactant upstream of the three-phase separator.

24. The method of claim 22, wherein adding anionic surfactant comprises injecting the anionic surfactant downstream of the three-phase separator and upstream of the one or more hydrocyclone batteries.

25. The method of claim 22, wherein adding anionic surfactant comprises injecting the anionic surfactant downstream of the electrostatic treater and upstream of the one or more hydrocyclone batteries.

26. The method of claim 22, wherein adding cationic polyelectrolyte comprises injecting the anionic surfactant downstream of the three-phase separator and upstream of the one or more hydrocyclone batteries.

27. The method of claim 22, wherein adding cationic polyelectrolyte comprises injecting the anionic surfactant downstream of the electrostatic treater and upstream of the one or more hydrocyclone batteries.

28. The method of claim 22, wherein adding cationic polyelectrolyte comprises injecting the anionic surfactant upstream of the flotation and downstream of the one or more hydrocyclone batteries.
